(19) United States
(12) Patent Application Publication
(10) Pub. No.: US 2024/0354661 A1
(43) Pub. Date: Oct. 24, 2024

(54) METHODS AND DEVICES FOR OPERATING PREDICTIVE ENGINES

(71) Applicant: Automated Machine Learning Limited, Kowloon Bay (HK)

(72) Inventor: Long Heng LIM, Kowloon Bay (HK)

(21) Appl. No.: 18/213,477

(22) Filed: Jun. 23, 2023

(30) Foreign Application Priority Data
Apr. 18, 2023 (CN) 202310409827.7

(51) Int. Cl. G06N 20/20

(52) U.S. Cl. CPC G06N 20/20

(57) ABSTRACT

The present disclosure relates to methods and devices for operating predictive engines. The present disclosure primarily includes the following features: generating two or more models with different engine structures and parameter sets; generating two or more states according to data and features; deploying the models or part of the models to the states; selecting a top-ranked model in each state; deploying the selected models by states to a live engine; determining a probabilistic weight for each state according to live data and features; ensembling a plurality of prediction results of the models for the states using respective probabilistic weights; and serving the ensembled prediction results as an output of the predictive engine. A machine learning engine responding rapidly, accurately and efficiently to environmental changes is thereby provided.

### FIELD OF THE DISCLOSURE

The present disclosure relates to machine learning, and in particular to methods, systems and computer program products for operating predictive engines in which models are utilized to make predictions about outcomes.

The present disclosure also relates to corresponding methods, systems and computer program products for evaluating and tuning predictive engines.

### BACKGROUND OF THE DISCLOSURE

A machine learning engine (or “ML engine” for short) provides a series of machine learning analytic functions to perform analysis on complete data sets.

Data scientists typically train an ML engine and select the best model for deployment. They may come back some time later to study the performance of the deployed model. If there is a deterioration of the performance metrics, they will tune and retrain the model and ultimately choose the best one for redeployment. Consequently, this creates unnecessary human touch and delays and leads to a sluggish response to the ever-changing environment.

In addition, the inventors have noticed that the existing ML engines suffer from other inefficiencies that burden data scientists. In particular, most ML engines rely on highest scoring models in providing prediction results. While such models can provide good prediction results, they do not allow the ML engines to learn from their previous mistakes.

Moreover, there are currently many ML engines that attempt to achieve what is accomplished with the brain. Among them, some of the well-known examples include DataRobot, H2O and Google AutoML. These share many similarities and outperform other ML engines in various aspects. Since the frequency of model training determines the pertinence of the best models developed by the ML engines to the current environment, the more frequently the models are trained, the higher the pertinence.

However, for these prior-art ML engines, they typically implement model training processes after an extended period of time (e.g., 6 months or a year). As such, the static nature between model training days prevents the models from capturing changes in the current environment.

Nevertheless, there are some attempts in the prior art to support dynamic model selection. For example, U.S. Pat. No. 9,135,559 B1 discloses a method for creating, evaluating and tuning a predictive engine for machine learning, the method comprising: deploying the predictive engine with an initial parameter set; receiving queries to the deployed engine variant and in response, generating prediction results; associating the queries, the prediction results, and actual results with a replay tag; evaluating the performance of the deployed engine variant; generating a new engine parameter set based on tuning of one or more parameters of the initial engine parameter set according to the evaluation results; and deploying a new engine variant to replace the initial engine variant.

US 2017/0293629 A1 and US 2014/0258189 A1 also disclose how to generate ML engines. However, the solutions disclosed in these literatures all fail to attain the following objects: 1) a state-driven model selection responding immediately to the latest state; 2) the ensembling of state prediction results using state probabilities; and 3) the introduction of a reward/penalty feedback to adjust weights of state probabilities and thus to realize the retuning and optimization of predictive engines.

### SUMMARY OF THE DISCLOSURE

In light of the above-mentioned many disadvantages of the existing ML engines, the object of the present disclosure is to provide an ML engine that responds rapidly, accurately and efficiently to environmental changes. Since the ML engine is used for prediction in the present disclosure, it may also be referred to as an ML predictive engine. This object is fulfilled by the technical solutions described below.

The basic operating principle underlying the ML engine of the present disclosure is as follows. Firstly, raw data undergo different states after entering into the ML engine. Secondly, within each state, N (N being equal to or greater than 2) models are generated based on the raw data compounded with a myriad of pre-set features. Among the N models, the ML engine selects the best model for each state, and identifies or determines the state of the best model after taking into account of a different probability of the best model being generated from each state. Thirdly, the identified model produces the prediction results. Additionally or optionally, with the prediction results, the ML engine will evaluate every prediction result and classify it either as a reward or a penalty subject to the accuracy of the prediction, and finally apply the evaluation results as new criteria for selecting the best models in the future.

Specifically, a method for operating a predictive engine according to the present disclosure comprises: generating two or more models with different engine structures and parameter sets; generating two or more states according to data and features; deploying the models or part of the models to the states; selecting a top-ranked model in each state; deploying the selected models by states to a live engine; determining a probabilistic weight for each state according to live data and features; ensembling a plurality of prediction results of the models for each state using respective probabilistic weights; serving the ensembled prediction results as an output of the predictive engine.

Preferably, the method may further comprise: evaluating a performance of the output, the model selection, and the probabilistic weights by computing one or more evaluation results based on at least one evaluation metric. The probabilistic weights of the states may then be preferably updated through rewards or penalties according to the performance, thereby tuning the predictive engine.

Thereby, the present disclosure allows for on-the-fly or dynamic selection of models according to the states defined by live data, while ensembling the prediction results of the states and optionally introducing a feedback mechanism such as rewards and penalties. The ML engine of the present disclosure is capable of being equipped and embedded with countless information on a 24/7 basis and searching for the best model to deploy, thereby producing an “on-the-fly” model that reflects the ever-changing environment. Moreover, the ML engine of the present disclosure may have another critical feature, i.e., a feedback loop. By leveraging the feedback from previous predictions, the ML engine can learn from its previous performance and make use of what it has learnt in addressing similar problems in the future. Here, the “on-the-fly” functionality of the present disclosure may preferably be coupled with the feedback loop to further enhance the ML engine or the “ML Brain” by providing instant feedback regarding the accuracy of the models.

In the present disclosure, the technical feature “state” may be external data sets outside of training data or may be derived from the training data. In the field of finance, for example, inflation, employment and PMI data may be used to define states, e.g., inflation growing/falling, industry-manufacturing growing/declining. Then, the training data may be historical transactions of a company to determine the risk of giving it a credit line, or stock prices to determine predicted prices of a company. “State” may be derived from data/features, but not a must.

For industrial plants, the “state” could be the status of the machine, e.g., how many months/years different parts/components have been running, or external functions, e.g., outdoor humidity, temperature. Then, we can use the data/features (e.g., data/features of the input materials) to predict the upcoming production rate or chances of repair needed and therefore to prepare suitable inventory and spare-part storage.

For automation (e.g., text-writing), the “state” could be the status of the computer, e.g., what applications have been opened, or external factors, e.g., morning, working hours, evening. Then, the auto-filling writing (predictive) engine can suggest different texts for the user to complete his or her writing. For example, in the morning/evening, the predictive engine may provide more personal suggestions, while more business-related suggestions are provided during working hours.

For transportation, the “state” could be which day of the week, or whether it is a holiday, or traffic conditions of other routes. Then, the traffic/route predictive engine can suggest which driving routes the user should take according to their corresponding conditions (data/features) with the consideration of the chances of traffic impacts by external “states”.

In the present disclosure, “ensembling” is a machine learning technique that may combine multiple base models to generate an optimal predictive model. “Ensembling” may refer to combining a plurality of prediction results of states/models.

A first technical advantage of the present disclosure is related to the nature of input data. While the ML engine created by the prior art (e.g., U.S. Pat. No. 9,135,559 B1) relies on data generated in evaluation results, the ML engine of the present disclosure can rely on live data to determine states and thus selected models. Therefore, the prediction by the present disclosure can better reflect and respond to the current environment.

A second technical advantage of the present disclosure attributes to the processing of input data. In the models of the present disclosure, data will undergo different states as part of the data generation process. By taking into account of models in different states, the ML engine of the present disclosure can provide more accurate predictions. In contrast, ML engines created by the prior art do not involve states and thus do not have the advantages of the present disclosure.

A third technical advantage of the present disclosure is associated with the breadth of the ML engine. Unlike the prior art, the ML engine of the present disclosure does not focus on evaluating a single model at a time. Instead, it can generate different models and manipulate different variables simultaneously. The final prediction is a probabilistic combination of outputs from selected models across various states, thereby improving the accuracy of the prediction.

A fourth technical advantage of the present disclosure attributes to the feedback mechanism with rewards/penalties to states to reflect the evaluation results of previous predictions, thus offering the possibility to dynamically tune and optimize the ML engine.

According to a preferred embodiment of the method of the present disclosure, the models may be generated from data, features and/or data derived from data; the top-ranked models may also be selected by ranking one or more performance metrics and/or correlating with other models; the probabilistic weights may likewise be determined using probabilities of the current states according to the latest data.

The method of the present disclosure may advantageously be applied to industrial production, such as the production of a plant. In this scenario, the state is for example the state of a plant machine, including the number of years and months that machine components have been in operation, an outdoor temperature, and/or an outdoor humidity, and the predictive engine is used to predict productivity of the plant or a probability of the machine requiring maintenance.

The method of the present disclosure may also be advantageously applied to the prediction of computer use by a user. In this scenario, the state refers to the state of the computer, including applications that have been opened on the computer, time of day, and/or working hours, and the predictive engine is used to predict the purpose or task for which the user is using the computer.

The method of the present disclosure may also be advantageously applied to the prediction of traffic conditions. In this scenario, the state refers to the state of the traffic, including traffic conditions on respective routes, the date, and/or whether it is a holiday, and the predictive engine is used to predict a probability of traffic congestion.

The method of the present disclosure may also be advantageously applied to the prediction of consumption. In this scenario, the state refers to a spending appetite of consumers, including a type of spending and/or a level of spending, and the predictive engine is used to predict a probability of the consumers shopping online.

The method of the present disclosure may also be advantageously applied to the prediction of the goodwill of a company. In this scenario, the state refers to market or financial conditions, and the predictive engine is used to predict asset prices or risks. Alternatively, the state may refer to inflation or manufacturing levels, and the predictive engine is used accordingly to predict the risk of lending to a company or to predict the stock price of the company.

The present disclosure also provides a system for operating a predictive engine comprising: a processor; a computer-readable working memory; a predictive engine stored in the working memory; and a non-volatile computer-readable storage medium for storing program codes, the stored codes being capable, when executed by the processor, of causing the following steps to be performed: generating two or more models with different engine structures and parameter sets; generating two or more states according to data and features; deploying the models or part of the models to the states; selecting a top-ranked model in each state; deploying the selected models by states to a live engine; determining a probabilistic weight for each state according to live data and features; ensembling a plurality of prediction results of the models for each state using respective probabilistic weights; serving the ensembled prediction results as an output of the predictive engine.

The system may further preferably be configured to: evaluate a performance of the output, the model selection, and the probabilistic weights by computing one or more evaluation results based on at least one evaluation metric. Preferably, the system may further be configured to update the probabilistic weights of the states through rewards or penalties according to the performance, thereby tuning the predictive engine.

Preferably, the system may be configured to generate the models from data, features and/or data derived from data. The top-ranked models are selected by ranking one or more performance metrics and/or correlating with other models. The probabilistic weights are determined using probabilities of the current states according to the latest data.

It is noted herein that the improved or preferred embodiments of the method of the present disclosure are equally applicable to the system of the present disclosure, the latter thus having corresponding technical effects and advantages as well.

The present disclosure also provides a computer program comprising a program code portion, the program code portion being adapted to perform the steps of the method of the present disclosure when being executed on a processor or computer. Accordingly, the present disclosure also relates to a corresponding computer program product comprising a program code portion, the program code portion being adapted to perform the steps of the method of the present disclosure when being executed on a processor or computer. The present disclosure relates in particular to a computer readable storage medium storing a computer program, the computer program comprising a program code portion, the program code portion being adapted to perform the steps of the method of the present disclosure when executed on a processor or computer.

### BRIEF DESCRIPTION OF THE DRAWINGS

Embodiments of the method, device and system in accordance with the present disclosure are illustrated by way of examples in the accompanying drawings and are further elaborated thereafter, in which:

FIG. 1 is a diagram showing the structure of a predictive engine according to the prior art;

FIG. 2 is a schematic diagram showing a method or system in accordance with an embodiment of the present disclosure; and

FIG. 3 is a schematic diagram showing a method or system in accordance with another embodiment of the present disclosure.

### DETAILED DESCRIPTION OF THE DISCLOSURE

Some illustrative definitions are provided herein to assist in understanding the present disclosure, but these definitions are not to be read as restricting the scope of the present disclosure. The terms may be used in the form of nouns, verbs or adjectives, within the scope of the definitions.

“Predictive engine” or “ML predictive engine” refers to program code components that are used to make predictions, for example, of how a user might behave or act given certain inputs. “Data source” refers to a component of a predictive engine for reading data from one or more source(s) of data storage, wherein the data could be training data, test data, real data, live data, historical data, simulated data, and so forth. “Data preparator” refers to a component of a predictive engine for automatic preprocessing of data from any data source, possibly into a desired format. The data preparator prepares and cleanses data according to what the predictive engine expects. “Algorithm” refers to an algorithmic component of a predictive engine for generating predictions and decisions. The Algorithm component includes machine learning algorithms, as well as settings of algorithm parameters that determine how a predictive model is constructed. A predictive engine may include one or more algorithms, to be used independently or in combination. Parameters of a predictive engine specify which algorithms are used, algorithm parameters used in each algorithm, and how results of each algorithm are congregated or combined to arrive at a predictive engine result, also known as an output or prediction. “Serving” component refers to a component of a predictive engine for returning prediction results, and for adding custom business logic.

If an engine has multiple algorithms, the Serving component may combine multiple prediction results into one. “Evaluator” or “Evaluation” component refers to a component of a predictive engine for evaluating the performance of the prediction process to compare different algorithms as well as different engine variants. “Engine variant”, “variant”, and “predictive engine variant” refer to a deployable instance of a predictive engine, specified by a given engine parameter set. The engine parameter set includes parameters that control each component of a predictive engine, including its Data Source, Data Preparator, Algorithm, Serving, and/or Evaluator components.

One of the highlights of the ML engine or ML brain of the present disclosure resides in its capacity to leverage live data to define current states, so as to select corresponding models at a fast speed. Specifically, in order for the “ML engine” to provide an unbiased solution to its users, the present disclosure has deployed a plurality of states and introduced model selection processes within each state. Despite these processes, the ML engine has proven that it can function at a rapid speed with constant inflow of live data. Furthermore, the processing speed of the ML engine can also be seen in its feedback loop. This has proven to be important in the face of an evolving environment. With this feature, the ML engine can quickly adapt to the new environment by evaluating its previous results.

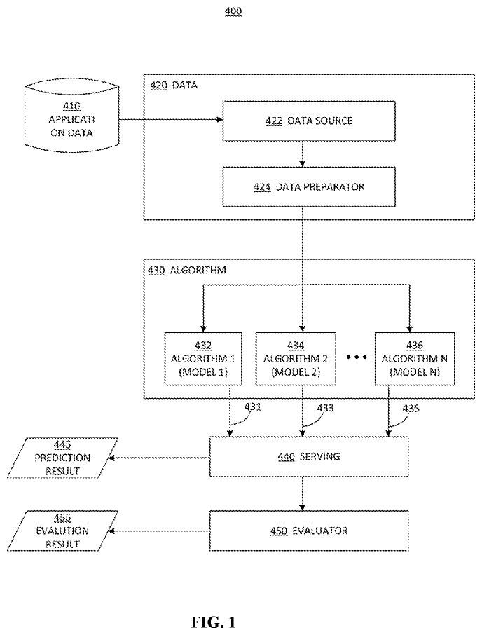

FIG. 1 is a diagram showing the overall structure of a predictive engine 400 according to the prior art. Predictive engine 400 may be separated into four major components, namely, Data 420, Algorithm 430, Serving 440, and Evaluator 450. This structure is also known as a “DASE” architecture. This DASE architecture provides a separation of concerns (SoC) that allows developers to exchange and replace individual components in predictive engine design. The first Data component 420 refers to data source 422 and data preparator 424. The second Algorithm component 430 of predictive engine 400 comprises one or more algorithms 432 to 436. Predicted results 431, 433 and 435 are passed to Serving component 440. The Serving component 440 can combine, filter, and further process prediction results according to real time business rules to generate predicted result 445. However, in this prediction structure of the prior-art predictive engine 400, the element of “state” as proposed in the present disclosure is not provided or considered.

In addition, in the prior art illustrated in FIG. 1, to evaluate the performance of the prediction process to compare different algorithms, algorithm parameters settings, as well as different engine variants, an Evaluator component 450 receives data from Serving component 440, and applies one or more metrics to compute evaluation results 455 as an output. Evaluator 450 may receive actual results, including correct values, user actions, or actual user behaviors from a datastore or a user application for computing evaluation metrics. An actual result refers to a correct prediction result or an actual outcome of a prediction task. If a predicted result is the same as an actual result, the predicted result can be considered as an excellent prediction. Prediction result 445 and evaluation result 455 can be passed to other components within a PredictionIO server, such that developers are enabled to customize engine components, evaluate predictive models, and tune predictive engine parameters to improve performance of prediction results. However, such tuning is not on-the-fly or dynamic, and is thus not able to provide instant feedback on the accuracy of the models, nor is it able to generate “on-the-fly” models that reflect the ever-changing environment, which is not conducive to instant optimization or enhancement of the ML engine or “ML brain”.

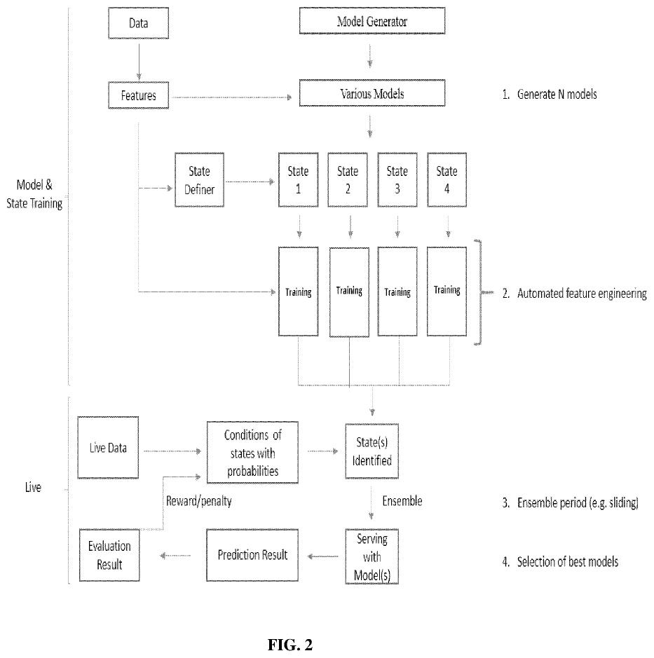

FIG. 2 illustrates an embodiment in accordance with the present disclosure that is applicable to both the method and the system and device of the present disclosure. According to the method for operating a predictive engine as shown in FIG. 2, accurate prediction results can be provided, and the predictive engine can also be evaluated and tuned in real time.

Specifically, feature values are first extracted from an initial data set in accordance with the present disclosure to form a simplified non-redundant feature set, or a feature vector as is also referred to. On the basis of these features, N models with different engine structures and parameter sets, typically two or more models, are generated by a model generator. These models may be generated simultaneously or sequentially. Here, the models may be generated from data, features, and/or data derived from data. The parameter sets may be generated by a parameter generator, or by adding or replacing control parameters on the basis of a base engine parameter set. Alternatively, a list of engine parameters is generated from a base engine parameter set by incrementally changing the value of one parameter within the base parameter set. The base engine parameter set may be generated manually by an operator, or may be generated automatically. In some embodiments, the base engine parameter set may be derived from previous engine parameter set tuning and evaluation steps. The base engine parameter set may also be included in the newly generated engine parameter sets. In other words, one of the newly generated engine parameter sets may equal to the base engine parameter set.

Next, in accordance with this embodiment of the present disclosure, two or more states are defined based on data and features, such as state 1, state 2, state 3, state 4. In the present disclosure, the technical feature “state” may be an external data set outside of training data or may be derived from training data. For example, the “state” may refer to the status of the machine in a plant, e.g., how many months/years different parts/components have been running, or it may be an external function, e.g., outdoor humidity, temperature. Accordingly, we can use data/features (e.g., data/features of input materials) to predict the upcoming production rate or chances of repair needed and therefore to prepare suitable inventory and spare-part storage. For automation (e.g., text-writing), the “state” could be the status of the computer, e.g., what applications have been opened, or external factors, e.g., morning, working hours, evening. Then, the auto-filling writing (predictive) engine can suggest different texts for the user to complete his or her writing. For example, in the morning/evening, the predictive engine may provide more personal suggestions, while more business-related suggestions are provided during working hours. For transportation, the “state” could be which day of the week, or whether it is a holiday, or traffic conditions of other routes. Then, the traffic/route predictive engine can suggest which driving routes the user should take according to their corresponding conditions (data/features) with the consideration of the chances of external “states” affecting the traffic.

After the states are defined, the models or part of the models are deployed to the states according to this embodiment of the present disclosure, where various ML models with specific configurations/hyper-parameters are assigned to each state. Such models/parameters may be selected by human experience or learnt from historical backtests. There is no perfect model to choose from, but more often various choices (e.g., one SVM, two NN, two regression models) are applied for states to use. As shown in FIG. 2, this embodiment of the present disclosure defines state 1, state 2, state 3, and state 4. Thus, a number of models can be selected from those models to be trained in state 1, state 2, state 3, and state 4, respectively, in order to obtain a number of trained prediction models. This process mainly includes Automated Feature Engineering. Automated feature engineering is a technique for extracting useful and meaningful features using a framework applicable to any problem, which enables data scientists to spend more time on other components of machine learning, thereby increasing productivity.

After the training process, the top-ranked model in each state is selected in accordance with this embodiment of the present disclosure. Preferably, the top-ranked model may be selected by ranking one or more performance metrics and/or correlating with other models. Here, the top-ranked model 1 in state 1, the top-ranked model 2 in state 2, the top-ranked model 3 in state 3, and the top-ranked model 4 in state 4 can be selected respectively. Based on the selected top-ranked models 1 to 4, the selected models 1 to 4 are deployed to a live engine by states 1 to 4 respectively in accordance with this embodiment of the present disclosure. In the context of the present disclosure, deployment may refer to placing an ML model into an environment where it can do what it was created to do.

When using the predictive engine in the embodiment of the present disclosure, live data is received via an input interface. Based on the live data and features, a probabilistic weight can be determined for each of states 1 to 4. The probabilistic weights may preferably be determined using probabilities of the current states according to the latest data. A plurality of prediction results given by models 1 to 4 for states 1 to 4 are ensembled using the respective probabilistic weights. As described above, “ensemble” may combine multiple base models to generate an optimal prediction model. In this embodiment, “ensemble” refers to combining multiple prediction results of states/models. For example, in an equal-weight scenario with 3 prediction results of 1, 1, 0, the “ensembling” yields (1+1+0)/3=0.66>0.5, which will then predict the outcome as 1. Of course, there may be scenarios where the weights are not equal. For example, if the probabilities of the three predicted results 1, 1, and 0 are 0.7, 0.2, and 0.1 respectively, the “ensembling” will yield (1×0.7+1×0.2+0×0.1)=0.9>0.5, which will also predict the outcome as 1.

Finally, after multiple prediction results are ensembled, the ensembled prediction result may be provided to the user as an output of the predictive engine.

Preferably, this embodiment of the present disclosure may be further optimized and improved. In order for the predictive engine to be evaluated and tuned, a performance of the output, the model selection, and the probabilistic weights may be evaluated by computing one or more evaluation results based on at least one evaluation metric, and then the probabilistic weights of the states are updated through rewards or penalties according to the performance, thereby tuning and optimizing the predictive engine. For example, in the case of good evaluation results, a reward mechanism may be introduced to increase the probabilistic weight of a certain state, thus improving the prediction accuracy of the predictive engine; conversely, in the case of unsatisfactory evaluation results, a penalty mechanism may be introduced to decrease the probabilistic weight of a certain state, thus also improving the prediction accuracy of the predictive engine. Through this reward or penalty mechanism, the probabilistic weight of each state will change accordingly, thus exerting a corresponding influence on the identified states and consequently on the ensembled result.

The industrial applicability of the ML engine according to this embodiment of the present disclosure may be seen in a variety of industries including, but not limited to, asset management, retailing, industrial plants, automation and transportation. In respect of these industries, the technical merits of the ML engine lie in its versatility, efficiency, and dynamics. In terms of versatility, the ML engine of the present disclosure is compatible with data across different disciplines and capable of providing useful results accordingly. This presents boundless opportunities for decision makers across various industries by empowering them with insights to make informed decisions as part of their long-term strategies for growth and creation of new technologies. In addition to versatility, the ML engine of the present disclosure is proven to be highly efficient due to its multi-model structure. As part of the data processing, the data undergo different states and subsequently different models will be generated. Ultimately, these models will be taken into consideration when determining the best model.

Therefore, the ML engine can provide a holistic solution to its users. In terms of dynamic state, the ability to make decisions with live data based on the potential states represented by the data is a critical feature valued by most decision makers today given the rapid changes in the environment. With the ML engine or brain of the present disclosure, decision-makers can utilize this function and translate it into actionable solutions.

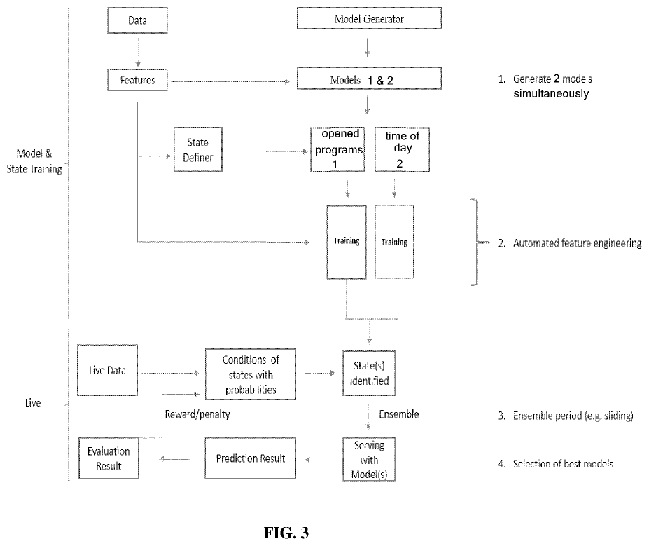

FIG. 3 illustrates an embodiment according to the present disclosure, which is applicable not only to the method of the present disclosure, but also to the system and device of the present disclosure. This embodiment is applied in the field of automation, for example, for realizing automation of a computer. Here, the state is the status of the computer, including which applications have been opened on the computer, or external factors, e.g., morning, working hours, evening. Then, the (predictive) engine using the computer for the auto-filling writing can suggest different texts for the user to complete his or her writing. For example, in the morning/evening, the predictive engine may provide more personal suggestions, while more business-related suggestions are provided during working hours. Specifically, according to the embodiment shown in FIG. 3, two states are defined by a state definer: “Open programs” and “Time of day”, and two models are respectively generated for the two states, that is, model 1, model 2. Models 1 and 2 are trained for the state “Open programs”; similarly, for the state “Time of day”, the other two models 1 and 2 generated therefor may also be trained. After training, by automated feature engineering, top-ranked models are selected separately for the states “Open programs” and “Time of day”, assuming that both are model 1. Then, according to the preset probabilistic weights of the states “Open programs” and “Time of day”, the model 1 for “Open programs” and the model 1 for “Time of day” are ensembled to provide the best prediction model. With this best prediction model, prediction results are provided for live data. Similar to the embodiment shown in FIG. 2, the prediction results may also be evaluated herein, and a reward/penalty mechanism may similarly be introduced, so as to tune and optimize the predictive engine.

Based on the embodiments shown in FIGS. 2 and 3, the present disclosure also proposes a corresponding system for operating the predictive engine, comprising: a processor; a computer-readable working memory; a predictive engine stored in the working memory; and a non-volatile computer-readable storage medium for storing program codes, the stored codes being capable, when executed by the processor, of causing the various steps of the method of the present disclosure to be performed.

All features described and/or illustrated in the description of the present disclosure can be advantageously combined with one another within the scope of the present disclosure. The present disclosure is not limited to the described embodiments. One of ordinary skill in the art would understand that the embodiments, structures, schematics, and flow diagrams may be performed in other orders or combinations without departing from the inventive concept of the present disclosure. Every embodiment may be unique, and methods/steps may be either shortened or lengthened, overlapped with the other activities, postponed, delayed, and continued after a time gap, such that every user is accommodated to practice the methods of the present disclosure.

The present disclosure may be implemented in hardware and/or in software. A user device may be a hardware that includes at least one processor coupled to a memory. The processor may represent one or more processors (e.g., microprocessors), and the memory may represent random access memory (RAM) devices comprising a main storage of the hardware, as well as any supplemental levels of memory e.g., cache memories, non-volatile or back-up memories (e.g. programmable or flash memories), read-only memories, etc. In addition, the memory may be considered to include memory storage physically located elsewhere in the hardware, e.g. any cache memory in the processor, as well as any storage capacity used as a virtual memory, e.g., as stored on a mass storage device.

The hardware of a user-device also typically receives a number of inputs and outputs for communicating information externally. For interface with a user, the hardware may include one or more user input devices (e.g., a keyboard, a mouse, a scanner, a microphone, a web camera, etc.) and a display (e.g., a Liquid Crystal Display (LCD) panel). For additional storage, the hardware my also include one or more mass storage devices, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware may include an interface with one or more networks (e.g., a local area network (LAN), a wide area network (WAN), a wireless network, and/or the Internet among others) to permit the communication of information with other computers coupled to the networks. It should be appreciated that the hardware typically includes suitable analog and/or digital interfaces to communicate with each other.

In general, the method executed to implement the embodiments of the present disclosure, may be implemented as part of an operating system or a specific application, component, program, object, module or sequence of instructions referred to as “computer programs” or “computer codes”. The computer programs typically comprise one or more instructions set at various times in various memory and storage devices in a computer, and that, when read and executed by one or more processors in a computer, cause the computer to perform operations necessary to execute elements involving the various aspects of the present disclosure. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), and digital and analog communication media.

Although the present disclosure has been described with reference to specific exemplary embodiments, it will be evident that the various modification and changes can be made to these embodiments without departing from the broader spirit of the present disclosure. Accordingly, the specification and drawings are to be regarded in an illustrative sense rather than in a restrictive sense. It will also be apparent to the skilled artisan that the embodiments described above are specific examples of a single broader disclosure which may have greater scope than any of the singular descriptions taught. There may be many alterations made in the descriptions without departing from the spirit and scope of the present disclosure.

What is claimed is:

1. A method for operating a predictive engine, comprising:
generating two or more models with different engine structures and parameter sets; generating two or more states according to data and features;
deploying the models or part of the models to the states;
selecting a top-ranked model in each state;
deploying the selected models by states to a live engine;
determining a probabilistic weight for each state according to live data and features;
ensembling a plurality of prediction results of the models for each state using respective probabilistic weights; and
serving the ensembled prediction results as an output of the predictive engine.

2. The method according to claim 1, wherein the method further comprises: evaluating a performance of the output, the model selection, and the probabilistic weights by computing one or more evaluation results based on at least one evaluation metric.

3. The method according to claim 2, wherein the method further comprises: updating the probabilistic weights of the states through rewards or penalties according to the performance, thereby tuning the predictive engine.

4. The method according to claim 3, wherein the models are generated from data, features and/or data derived from data.

5. The method according to claim 3, wherein the top ranked models are selected by ranking one or more performance metrics and/or correlating with other models.

6. The method according to claim 3, wherein the probabilistic weights are determined using probabilities of the current states according to the latest data.

7. The method according to claim 1, wherein the state comprises a status of a plant machine, including the number of years and months that machine components have been in operation, an outdoor temperature, and/or an outdoor humidity, and wherein the predictive engine is used to predict productivity of the plant or a probability of the machine requiring maintenance.

8. The method according to claim 1, wherein the state comprises a status of a computer, including applications already open on the computer, time of day, and/or working hours, and wherein the predictive engine is used to predict the purpose or task of a user using the computer.

9. The method according to claim 1, wherein the state comprises a state of traffic, including traffic conditions on each route, the date, and/or whether it is a holiday, and wherein the predictive engine is used to predict a probability of traffic congestion.

10. The method according to claim 1, wherein the state comprises a spending appetite of consumers, including a type of spending and/or a level of spending, and wherein the predictive engine is used to predict a probability of the consumers shopping online.

11. The method according to claim 1, wherein the state comprises market or financial conditions, and wherein the predictive engine is used to predict asset prices or risks, or is used to predict a risk of lending to a company or to predict a stock price of the company.

12. A system for operating a predictive engine, comprising:
a processor;
a computer-readable working memory;
a predictive engine stored in the working memory; and
a non-volatile computer-readable storage medium for storing program codes, the stored codes being capable, when executed by the processor, of causing the following steps to be performed:
generating two or more models with different engine structures and parameter sets; generating two or more states according to data and features;
deploying the models or part of the models to the states;
selecting a top-ranked model in each state;
deploying the selected models by states to a live engine;
determining a probabilistic weight for each state according to live data and features;
ensembling a plurality of prediction results of the models for each state using respective probabilistic weights; and
serving the ensembled prediction results as an output of the predictive engine.

13. The system according to claim 12, wherein the steps further comprise: evaluating a performance of the output, the model selection, and the probabilistic weights by computing one or more evaluation results based on at least one evaluation metric.

14. The system according to claim 13, wherein the steps further comprise: updating the probabilistic weights of the states through rewards or penalties according to the performance, thereby tuning the predictive engine.

15. The system according to claim 14, wherein the models are generated from data, features and/or data derived from data.

16. The system according to claim 14, wherein the top ranked models are selected by ranking one or more performance metrics and/or correlating with other models.

17. The system according to claim 14, wherein the probabilistic weights are determined using probabilities of the current states according to the latest data.

18. The system according to claim 12, wherein the state comprises a status of a plant machine, including the number of years and months that machine components have been in operation, an outdoor temperature, and/or an outdoor humidity, and wherein the predictive engine is used to predict productivity of the plant or a probability of the machine requiring maintenance.

19. The system according to claim 12, wherein the state comprises a status of a computer, including applications already open on the computer, time of day, and/or working hours, and wherein the predictive engine is used to predict the purpose or task of a user using the computer.

20. The system according to claim 12, wherein the state comprises a state of traffic, including traffic conditions on each route, the date, and/or whether it is a holiday, and wherein the predictive engine is used to predict a probability of traffic congestion.

21. The system according to claim 12, wherein the state comprises a spending appetite of consumers, including a type of spending and/or a level of spending, and wherein the predictive engine is used to predict a probability of the consumers shopping online.

22. The system according to claim 12, wherein the state comprises market or financial conditions, and wherein the predictive engine is used to predict asset prices or risks, or is used to predict a risk of lending to a company or to predict a stock price of the company.

23. A computer program product, comprising a computer program which, when executed on a processor, causes the steps of the method according to claim 1 to be performed.
